(19) United States
(12) Patent Application Publication
(10) Pub. No.: US 2020/0254862 A1
(43) Pub. Date: Aug. 13, 2020

(54) VEHICLE AUTOMATIC COVERING DEVICE

(71) Applicant: Yoon Sang DON, Seoul (KR)

(72) Inventor: Yoon Sang DON, Seoul (KR)

(21) Appl. No.: 16/639,368

(22) PCT Filed: Aug. 10, 2018
(86) PCT No.: PCT/KR2018/009165

§ 371 Date: Feb. 14, 2020

(30) Foreign Application Priority Data
Aug. 16, 2017 (KR) 10-2017-0103588

(51) Int. Cl. B60J 11/04

(52) U.S. Cl. CPC B60J 11/04

(57) ABSTRACT

The present invention relates to a vehicle automatic covering device and, more specifically, to a vehicle automatic covering device, which can be quickly provided by allowing a protective cover for covering a vehicle to be automatically unfolded, and is conveniently stored by allowing the protective cover to be automatically folded after use.

### TECHNICAL FIELD

The present invention relates to an vehicle automatic covering device and, more specifically, to an automatic covering device for a vehicle, which automatically unfolds a protective cover to cover the vehicle and allows rapid installation of the cover and, after use, automatically folds the protective cover to be easily accommodated and stored.

### BACKGROUND ART

A car parked outside in winter may have snow or frost formed on a car window due to the temperature difference between the outside and the inside of the car.

In particular, in the case of frost formed on a car window, if the frost is not completely removed, frost may be formed again on the window, thereby obscuring front view of a driver. As a result, the driver may have difficulty in driving the car.

Accordingly, in order to remove the frost, chemicals are generally used or an alternative tool (such as cassette tape) is often used to scrape and remove the frost. In particular, when a glass window is scraped using the tool, there is a problem of causing, for example, a scratch on an automobile.

In other words, it is important to prevent frost before it is formed rather than to remove the same after it is formed. Generally, a box or a cloth covers a window of an automobile to prevent formation of frost. Therefore, technologies relevant to such a protective cover for automobile have been developed.

In the past, the protective cover was basically provided when purchasing a vehicle. However, in recent years, a small number of users have used the cover due to inconvenience in use and low frequency in use thereof.

Meanwhile, as environmental pollution has currently become worse, a vehicle is more easily polluted due to pollutants such as minute dust, floating yellow dusts, yellow dust rain, yellow dust snow, etc. at the time of outside parking, therefore, a necessity for a protective cover is on the rise again.

Especially, although the number of vehicles is increasing globally, parking facilities are relatively insufficient and thus the vehicles are exposed to external pollution such as contaminants, wood resinous extract, bird droppings, etc. Further, even if parking inside, the vehicle is polluted due to indoor dust or the like. Accordingly, a protective cover is importantly demanded.

On the other hand, with respect to the protective cover for an automobile, Korean Patent Laid-Open Publication No. 10-2009-0083049 discloses a vehicle protective cover.

More particularly, the protective cover according to the above prior art includes: a cover cloth consisting of a center part to cover the roof of a vehicle, a front part to cover a front glass window of a driver's seat, a rear part to cover a rear glass window of the vehicle, and side parts to cover right and left side glass windows of the vehicle; a plurality of connection means which are provided on right and left sides as well as the front parts, and are inter-coupled to one another on the bottom of side mirrors of the vehicle to support the cover cloth to the vehicle; a fastening band provided on the side parts, and engaged and fixed to a door of the vehicle when the cover cloth is installed, thereby supporting the cover cloth on the vehicle; and another fastening band provided on the rear part, and fixed and supported to a trunk of the vehicle to support the cover cloth to the vehicle.

However, the above prior art has adopted a configuration wherein the center part to cover the roof of the vehicle, and the front part, the rear part and both side parts connected to the center part, respectively, are fixed to the outside of the vehicle by the fastening bands and thus may have a space between the front part and the side parts and/or between the side parts and the rear part. Accordingly, when the wind blows into the space, the fixed cover may be peeled off. Further, in the case where the cover is installed or the installed cover is removed, there is a problem that the user must directly fold and remove the same, or roll and store the same.

The prior air documents relating to the present invention may include, for example, Korean Patent Laid-Open Publication No. 10-2009-0083049 or the like.

### DISCLOSURE

### Technical Problem

The present disclosure has been made to overcome the aforementioned problems, and an object of the present disclosure is to provide an automatic covering device for a vehicle, characterized in that a protective cover may be automatically unfolded so as to be rapidly installed and, after use, may be automatically folded, thereby being easily accommodated or stored.

More particularly, the vehicle automatic covering device may include a foldable cover frame forming an outer frame of a protective cover, wherein the cover frame is automatically unfolded through elastic force while being folded again through driving force when the cover frame is in an unfolded state, thereby being accommodated along with the protective cover.

### Technical Solution

According to an aspect of the present invention to solve the above problems, there is provided an automatic covering device for a vehicle, which encloses an outer circumferential surface of the vehicle and protects the vehicle, and includes: a protective cover which is made of a waterproof and flame retardant material and has an area corresponding to the outer circumferential surface of the vehicle; a cover frame which is mounted along a rim of the protective cover to form an outer frame of the protective cover and is configured to be foldable such that the cover frame is automatically unfolded in a rectangular frame shape by elastic force or folded by external force so as to be accommodated along with the protective cover; and a folding member which folds the cover frame while providing the external force to the cover frame, wherein the cover frame includes: a plurality of unit frames continuously connected along the rim of the protective cover to form a rectangular frame; a hinge member rotatably provided at each connecting part of the unit frames to form joints and to thus allow the unit frames to be unfolded or folded; and an elastic wire for connecting the unit frames adjacent to each other among the above plural unit frames, wherein the adjacent unit frames provide the elastic force in an unfolding direction around the hinge member to press the unit frames, thereby unfolding the unit frames in a rectangular frame shape.

For instance, the elastic wire according to one embodiment may include: an elastic wire body which is fixed to the end of one among the adjacent unit frames while extending toward the end of the other one and stretching over the hinge member; and a spring which is provided on at least one of both ends of the wire body to fasten the wire body to the unit frame, and is made of an elastic material to press the adjacent unit frames so as to unfold the adjacent unit frames while providing elastic force in a direction of pulling the wire body.

Further, with respect to the cover frame, the ends of the unit frames coupled through the hinge member are each formed as an inclined surface and the inclined surfaces face one another by unfolding the unit frames through the elastic force of the elastic wire, whereby the unit frames may be prevented from being straightly unfolded.

For instance, the folding member according to one embodiment may include: a folding wire, one end of which is connected to each of the hinge members to form the apex of a rectangular frame, among the hinge members to configure the cover frame, while the other end extends toward the center of the rectangular frame; a bobbin which is rotatably provided at the center of the rectangular frame formed by the cover frame so that the other end of the folding wire is connected to the bobbin, rotates in one direction by external force to fold the unit frames while winding the folding wire, and reversely rotates to unwind the folding wire; a folding motor which provides rotational force to the bobbin to thus rotate the bobbin in one direction, locks the bobbin in a rotated state to prevent the bobbin from voluntarily rotating in a reverse direction; and a folding housing in which the bobbin and the folding motor are disposed, and the cover frame and the protective cover are accommodated.

For instance, the folding housing may include: a bottom body in which the bobbin and the folding motor are mounted, and the completely folded cover frame as well as the protective cover are accommodated; and a top cover switchably shielding the bottom body, wherein the top cover is screw-coupled to the bobbin to alternately open and close the bottom body while vertically ascending by rotation of the bobbin.

The folding member may further include a solar panel provided at an upper end of the folding housing to supply power to the folding motor.

### Advantageous Effects

As described above, with respect to the automatic covering device for a vehicle according to an embodiment of the present invention, the cover frame formed along the rim of the protective cover is configured of plural unit frames, which are automatically unfolded by elastic force, whereby the protective cover can be quickly opened and used. Further, the cover frame is automatically folded by operation of the folding motor forming the folding member, thereby accomplishing convenient accommodation of the cover.

Further, since the unit frames to form the cover frame are unfolded in a zigzag shape due to the inclined surface instead of being straightly unfolded so that, when the folding motor is operated, the unit frames may be smoothly folded.

Further, if the folding member is provided with a solar panel, the folding motor may be operated by a power supply in the solar panel, thereby achieving eco-friendly advantages.

Effects of the present invention are not limited to the functional effects mentioned above, and other effects not stated herein may also be clearly understood by those skilled in the art from description of the appended claims.

### DESCRIPTION OF DRAWINGS

FIG. 1 is a perspective view of the automatic covering device for a vehicle according to the present invention.

FIG. 2 is a configuration view illustrating a cover frame and a folding member in the automatic covering device for a vehicle according to the present invention.

FIG. 3 is a perspective view illustrating one example of the cover frame according to the present invention.

FIG. 4 is a front view illustrating another example of the cover frame according to the present invention.

FIG. 5 is a configuration view illustrating one example of the folding member according to the present invention.

FIG. 6 is a configuration view illustrating another embodiment of the present invention.

### BEST MODE

Hereinafter, preferred embodiments of the present invention without limitation thereto will be described in detail with reference to the accompanying drawings, wherein the same reference numerals are used to designate identical or similar elements, and redundant description thereof will be omitted. The suffixes “module” and “part” for components used in the following description are given or used in combination, considering ease of specification, and do not have their own meanings or roles.

Further, with respect to the following description of embodiments of the present invention, a detailed description of the related art will be omitted when it is determined to cloud the gist of the embodiments disclosed herein. Further, the accompanying drawings are provided only to more concretely explain the embodiments disclosed herein, however, are not intended to limit technical idea described in the present disclosure. Further, it is to be understood that all alterations, equivalents and/or alternatives are included in the scope and technical range of the present invention as claimed.

In addition, terms including ordinal numbers such as first, second, etc. may be used to describe various elements, but such elements are not limited to these terms. The above terms are used only for the purpose of distinguishing one component from another.

It is to be understood that, when an element is referred to as being “coupled” or “connected” to another element, this element may be directly coupled or connected to the other element or, otherwise, another element may be present between the above two elements. On the other hand, when an element is referred to as being “directly coupled” or “directly connected” to another element, it should be understood that there are no other elements between the above two elements.

In the following description, the singular forms such as “a”, “an” and “the” would include plural referents unless the context clearly dictates otherwise. Further, it is to be understood that the terms such as “include”, “comprise”, etc. are intended to designate the presence of one or more features, integers, steps, operations, elements, components or combinations thereof, without excluding the presence or possible addition of one or more other features, integers, steps, operations, elements, components or combinations thereof.

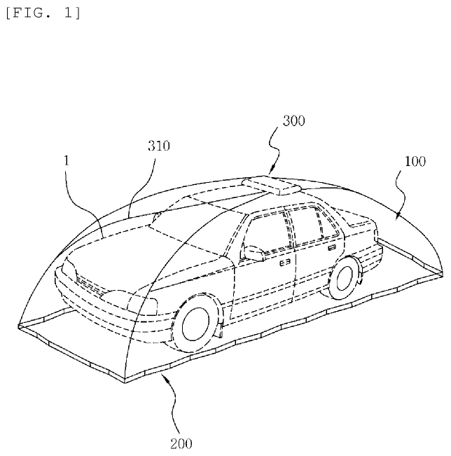

As shown in FIG. 1, the automatic covering device for a vehicle according to the present invention is used for protecting a vehicle 1 from contaminants by covering an outer circumferential surface of the vehicle 1, and may include a protective cover 100, a cover frame 200, and a folding member 300.

The protective cover 100 is made of a waterproof and flame retardant fabric to protect the vehicle from contaminants and may shield the outer circumferential surface of the vehicle while having an area and shape corresponding to the outer circumferential surface of the vehicle.

The protective cover 100 may be provided with each transparent window (not shown) in a site corresponding to a license plate of the vehicle and a site corresponding to a black box mounting position.

The cover frame 200 is a component to automatically unfold or fold the protective cover 100 for storage.

The cover frame 200 may be mounted along a rim of the protective cover 100 in a rectangular frame shape while being unfolded by elastic force so as to be unfolded together with the protective cover 100. On the other hand, the cover frame 200 may be folded by rotational force of a folding motor 330 described later, thereby being folded together with the cover 100 and accommodated.

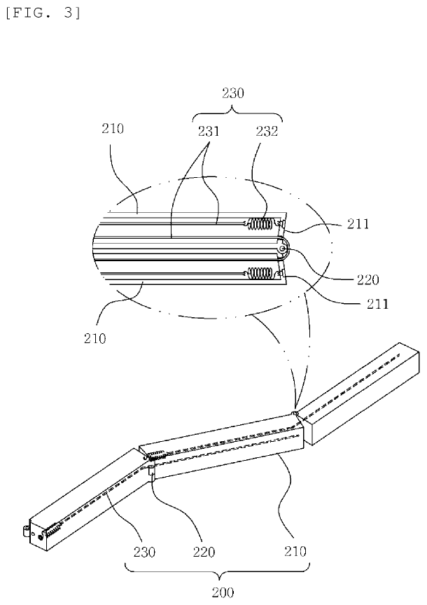

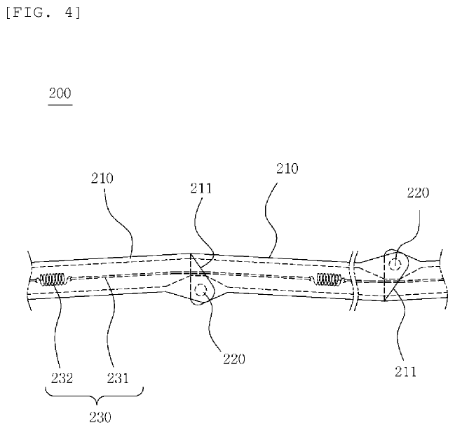

Specifically, as shown in FIGS. 3 and 4, the cover frame 200 may include unit frames 210, a hinge member 220 and an elastic wire 230.

The unit frame 210 may be provided in plural, and such plural unit frames may be continuously connected along the rim of the protective cover 100 to thus form a rectangular frame.

The hinge member 220 may be rotatably provided at a connecting portion of the unit frames 210 to form a joint of the unit frames 210.

That is, the hinge member 220 is a member that enables unfolding and folding of the unit frames 210 adjacent to each other (“adjacent unit frames”).

The elastic wire 230 is a component to provide elastic force so that the adjacent unit frames 210 can be unfolded, wherein the elastic wire may provide the elastic force in an unfolding direction of the unit frames 210 around the hinge member 220 while connecting the adjacent unit frames 210 to each other.

The elastic wire 230 may consist of a wire body 231 and a spring 232, as shown in FIG. 3.

The wire body 231 may be fixed to the end of one among the adjacent unit frames 210 while extending toward the end of the other one, and may be extended while stretching over the hinge member 220 that connects the unit frames 210.

The spring 232 may be provided on at least one of both ends of the wire body 231 to fasten the wire body 231 to the unit frame 210. The spring is made of an elastic material to thus provide elastic force in a direction of pulling the wire body 231, and may press the adjacent unit frames 210 so as to unfold the same, thereby unfolding the unit frames 210 in a rectangular frame shape.

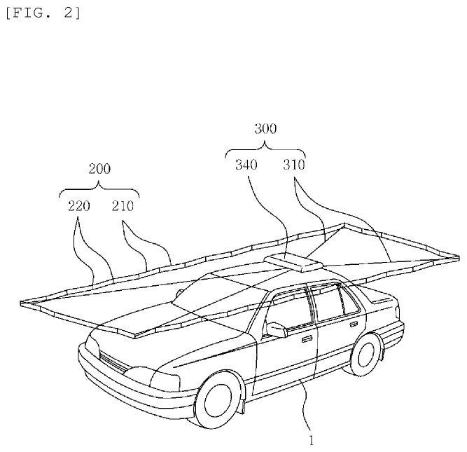

Herein, the adjacent unit frames 210 preferably have ends facing each other which are formed as inclined surfaces 211, as shown in FIGS. 2 and 3.

Accordingly, when the adjacent unit frames 210 are unfolded by the elastic force of the elastic wire 230, the inclined surfaces 211 may face each other, thereby being unfolded in a bent form rather than in a straight form.

In this regard, if the unit frames 210 are unfolded in a straight form, the elastic wire 230 may also be straight, whereby the unit frames 210 may not be easily folded. Therefore, the inclined surfaces 211 may be formed to be unfolded in a bent form. In this case, the unit frames 210 may be formed in a zigzag shape while forming a rectangular frame.

Meanwhile, with respect to the unit frames 210 as shown in FIG. 3, the inclined surfaces 211 facing each other may be formed to be symmetrical with each other. Alternatively, as shown in FIG. 4, the inclined surfaces 211 facing each other may be formed to have a slope in the same direction.

The folding member 300 is a component to provide external force to the cover frame 200 unfolded in a rectangular frame shape, thereby folding the cover frame 200 and accommodating the same along with the protective cover 100.

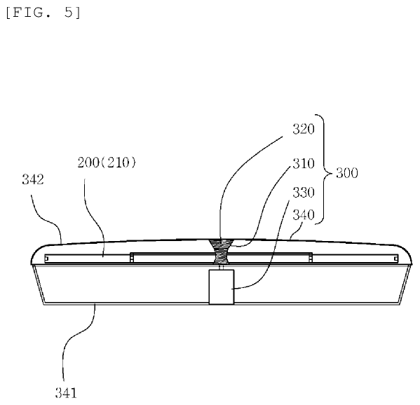

As shown in FIGS. 2 to 5, the folding member 300 may include a folding wire 310, a bobbin 320, a folding motor 330 and a folding housing 340.

The folding wire 310 provides force to pull and fold the cover frame 200 unfolded in a rectangular frame shape and, as shown in FIG. 2, may be connected to each of the hinge members 220 forming the apex of the rectangular frame, and extended toward a folding housing 340 described later, which is disposed at the center of the rectangular frame.

The folding housing 340 is disposed at the center of the cover frame 200 while forming a ship-like shape, which may accommodate a bobbin 320 and a folding motor 330 described later. Further, the completely folded cover frame 200 and the protective cover 100 may also be accommodated in the folding housing.

The folding housing 340 may consist of a bottom body 341 and a top cover 342.

The bobbin 320 and the folding motor 330 described later may be mounted in the bottom body 341, and the completely folded cover frame 200 and the protective cover 100 may also be accommodated in the bottom body 341.

In this regard, the top cover 342 may be manually opened and closed while shielding an upper portion of bottom body 341. Alternatively, the top cover 342 may be automatically opened and closed by rotation of the bobbin 320.

For instance, the bobbin 320 may be installed in the bottom body 342 together with the folding motor 330, while the top cover 342 may be screw-coupled to the inside of the bobbin 320 and vertically ascended through rotation of the bobbin 320.

That is, the top cover 342 may open the bottom body 341 while ascending by unidirectional rotation of the bobbin 320, thereby exposing the folding wire 310, the cover frame 200 and the protective cover 100.

Further, the top cover 342 may shield the bottom body 341 while descending by rotation of the bobbin 320 in the opposite direction, thereby accommodating the folding wire 310, the cover frame 200 and the protective cover 100.

The bobbin 320 winds the folding wire 310 to fold the unit frames 210 constituting the cover frame 200, and may be rotatably mounted on the folding housing 340 and connected to the folding wire 310.

The bobbin 320 may wind the folding wire 310 while rotating in one direction by the folding motor 330 described later so as to fold the unit frames 210. Further, the bobbin 320 may unwind the folding wire 310 while rotating in the opposite direction so as to allow unfolding of the unit frames 210 through elastic force of the elastic wire 230.

Herein, a single bobbin 320 may be used to wind four folding wires 310. Alternatively, a plurality of bobbins 320 may be used to wind two folding wires 310, respectively.

The folding motor 330 provides rotational force to the bobbin 320, and is installed in the folding housing 340 to rotate the bobbin 320 while being operated by a power source.

The folding motor 330 rotates the bobbin 320 through a reduction gear (not shown) and thus may prevent voluntary rotation of the bobbin 320.

That is, the cover frame 200 is locked in a folded state by the reduction gear in the folding motor 330, whereby voluntary unfolding of the cover frame by elastic force of the elastic wire 230 is prevented.

The folding motor 330 may be connected to an external power source, may be supplied with power through a battery (not shown), or may be supplied with power from a solar panel (now shown) installed in the folding housing 340.

Alternatively, the folding motor 330 may be controlled by a remote control (not shown) to rotate the bobbin 320.

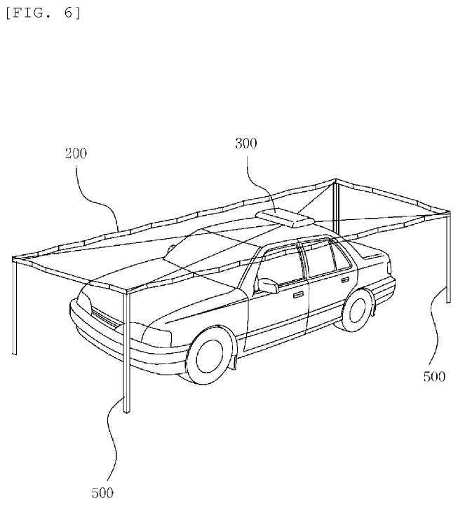

On the other hand, as shown in FIG. 6, the cover frame 200 may be detachably coupled with a plurality of posts 500, thereby forming the protective cover 100 in a sunshade shape.

The posts 500 may be configured to be adjustable in length with a telescopic structure.

A method of using the automatic covering device including the above-described components according to the present invention will be described below.

In order to unfold the protective cover 100, a user can unwind the folding wire 310 from the bobbin 320 by taking the folding housing 340 out of a trunk or the like of the vehicle, placing the same on a roof panel and then operating the folding motor 330 to rotate the bobbin 320. In this case, the top cover 342 ascends by rotation of the bobbin 320 to open the bottom body 341.

The unit frames 210 constituting the cover frame 200 are pressed in an unfolding direction by the elastic force of the elastic wire 230 when unwinding the folding wire 310, thereby being unfolded in a rectangular frame shape. At the same time, the protective cover 100 is also unfolded by the cover frame 200.

The user can lower the unfolded cover frame 200, as shown in FIG. 1, so as to complete installation of the protective cover 100.

When accommodating the protective cover 100, the user can lift up the cover frame 200 and then reversely rotate the bobbin 320 via the folding motor 300.

In this case, the folding wire 310 folds the unit frames 210 by pulling the same while being wound on the bobbin 320. Further, the upper cover 342 shields the bottom body 341 while descending by rotation of the bobbin 320, thereby accommodating the folding wire 310, the cover frame 200 and the protective cover 100.

As described above, with respect to the automatic covering device for a vehicle according to an embodiment of the present invention, the cover frame 200 provided along the rim of the protective cover 100 includes a plurality of unit frames 210 and is automatically unfolded by elastic force, whereby the protective cover 100 can be rapidly unfolded and used. Further, the cover frame 200 may be automatically folded by operation of the folding motor 330 constituting the folding member 300, thus being conveniently accommodated.

It will be apparent to those skilled in the art that the above-described embodiments are provided for illustrative purposes only and that other concrete modifications are easily implemented without departing from the spirit or essential characteristics of the embodiments described above. It is therefore to be understood that the above-described embodiments are considered to be illustrative and not to be restrictive in all respects. For instance, components described as a singular form may be separately implemented, and the components described as being used separately may also be implemented in a combined form.

It is to be understood that the scope of the present invention is defined by the appended claims rather than the foregoing description, and should be construed as including all changes and modifications derived from the meanings and range of the claims and the concept of equivalency thereof.

### DESCRIPTION OF REFERENCE NUMERALS

100: protective cover 200: cover frame
210: unit frame 220: hinge member
230: elastic wire 231: wire body
232: spring 300: folding member
310: folding wire 320: bobbin
330: folding motor 340: folding housing
341: bottom body 342: top cover
500: post

1. An automatic covering device for a vehicle to enclose an outer circumferential surface of the vehicle and protect the vehicle, comprising:
a protective cover which is made of a waterproof and flame retardant material and has an area corresponding to the outer circumferential surface of the vehicle;
a cover frame which is mounted along a rim of the protective cover to form an outer frame of the protective cover and is configured to be foldable such that the cover frame is automatically unfolded in a rectangular frame shape by elastic force or folded by external force so as to be accommodated along with the protective cover; and
a folding member which folds the cover frame while providing the external force to the cover frame,
wherein the cover frame includes: a plurality of unit frames continuously connected along the rim of the protective cover to form a rectangular frame; a hinge member rotatably provided at each connecting part of the unit frames to thus allow the unit frames to be unfolded or folded while forming a joint; and an elastic wire for connecting the unit frames adjacent to each other (“adjacent unit frames”) among the above plural unit frames, wherein the adjacent unit frames provide the elastic force in an unfolding direction around the hinge member to press the unit frames, thereby unfolding the unit frames in a rectangular frame shape.

2. The device according to claim 1, wherein the elastic wire includes: an elastic wire body which is fixed to the end of one among the adjacent unit frames while extending toward the end of the other one and stretching over the hinge member; and
a spring which is provided on at least one of both ends of the wire body to fasten the wire body to the unit frame and is made of an elastic material to press the adjacent unit frames so as to unfold the adjacent unit frames while providing elastic force in a direction of pulling the wire body.

3. The device according to claim 1, wherein the ends of the unit frames coupled through the hinge member in the cover frame are each formed as an inclined surface, wherein the inclined surfaces face one another by unfolding the unit frames through the elastic force of the elastic wire, whereby the unit frames are prevented from being straightly unfolded.

4. The device according to claim 1, wherein the folding member includes:
a folding wire, one end of which is connected to each of the hinge members to form the apex of a rectangular frame, among the hinge members to configure the cover frame in an unfolded state in a rectangular frame shape, while the other end extends toward the center of the rectangular frame;
a bobbin which is rotatably provided at the center of the rectangular frame formed by the cover frame so that the other end of the folding wire is connected to the bobbin, rotates in one direction by external force to fold the unit frames while winding the folding wire, and reversely rotates to unwind the folding wire;
a folding motor which provides rotational force to the bobbin to thus rotate the bobbin in one direction, and locks the bobbin in a rotated state to prevent the bobbin from voluntarily rotating in a reverse direction; and
a folding housing in which the bobbin and the folding motor are disposed, and the cover frame and the protective cover are accommodated.

5. The device according to claim 4, wherein the folding housing includes:
a bottom body in which the bobbin and the folding motor are mounted, and the completely folded cover frame as well as the protective cover are accommodated; and
a top cover switchably shielding the bottom body, wherein the top cover is screw-coupled to the bobbin to alternately open and close the bottom body while vertically ascending by rotation of the bobbin.

6. The device according to claim 4, wherein the folding member further includes a solar panel provided at an upper end of the folding housing to supply power to the folding motor.
